(19) United States
(12) Patent Application Publication
(10) Pub. No.: US 2013/0131255 A1
(43) Pub. Date: May 23, 2013

(54) ADDITIVES FOR STABILIZING POLYCONDENSATES WITH RESPECT TO HYDROLYSIS

(71) Applicants: Laurence POTTIE, Koeln (DE); Theo SMIT, Heidelberg (DE); Simone SCHILLO, Ludwigshafen (DE); Volker FRENZ, Altleiningen (DE); Roelof VAN DER MEER, Halsteren (DE)

(72) Inventors: Laurence POTTIE, Koeln (DE); Theo SMIT, Heidelberg (DE); Simone SCHILLO, Ludwigshafen (DE); Volker FRENZ, Altleiningen (DE); Roelof VAN DER MEER, Halsteren (DE)

(21) Appl. No.: 13/676,396

(22) Filed: Nov. 14, 2012

Related U.S. Application Data
(60) Provisional application No. 61/560,834, filed on Nov. 17, 2011.

(51) Int. Cl. C08K 5/353; C08K 5/1515; C08K 5/1525; C08K 5/29

(52) U.S. Cl. CPC C08K 5/353; C08K 5/29; C08K 5/1515; C08K 5/1525
USPC 524/513; 525/374; 525/122; 525/386; 525/375; 525/176

(57) ABSTRACT

A mixture comprising at least one polyfunctional chain extender having at least three reactive groups, and at least one mono- or difunctional hydrolysis stabilizer, where the chain extenders and the hydrolysis stabilizers react with the terminal groups of polymers in the molten or solid state of the polymers to form a chemical bond. Use of such mixtures as stabilizers for polymers. Methods for stabilizing polymers with respect to molecular weight loss, where an effective amount of such a mixture is added to the polymer.

The present invention relates to mixtures comprising polyfunctional chain extenders and mono- or difunctional hydrolysis stabilizers, for polymers. The invention further relates to mixtures of polyfunctional chain extenders, of mono- or difunctional hydrolysis stabilizers, and of polymers. The invention further relates to the use of the mixtures comprising polyfunctional chain extenders and mono- or difunctional hydrolysis stabilizers for stabilizing polymers, and to methods for stabilization with respect to molecular weight loss in polymers.

Further embodiments of the present invention can be found in the claims, in the description, and in the examples. It is self-evident that the features described above for the subject matter of the invention, and the features that remain to be explained hereinafter, can be used not only in the specific combination respectively stated but also in other combinations, without exceeding the scope of the invention. Other preferred and, respectively, very preferred embodiments of the present invention are those in which all of the features of the subject matter of the invention have the preferred and respectively very preferred meanings.

Chain extenders were initially developed in order to obtain polycondensates with high molecular weights via reactive extrusion. By way of example, WO 98/47940 A1 describes bifunctional caprolactam chain extenders for producing high-molecular-weight polyesters and polyamides.

Polyfunctional chain extenders having three or more reactive groups lead to branched structures. The use of additives of this type in a polymer matrix therefore leads not only to chain extension but often to branching phenomena, where these markedly increase viscosity on processing in the melt. Additives of this type are described in U.S. Pat. No. 5,354,802 for use in, for example, polyesters or polyamides.

WO 2004/067629 A1 describes the use of chain extenders in diluted form in an inert carrier polymer.

U.S. Pat. No. 6,984,694 B2 describes the use of copolymers comprising epoxy-functionalized (meth)acrylic acid monomers, styrene and/or (meth)acrylic acid monomers as chain extenders.

Carbodiimides are known as hydrolysis stabilizers by way of example from U.S. Pat. No. 5,439,952, EP 799843 A1, or EP 1262511 A2. However, their use often produces toxic byproducts, such as phenyl isocyanates. Problems with toxicity are avoided by using oligomeric or polymeric carbodiimides.

By way of example, DE 3217440 A1 describes polyethylene terephthalates with improved hydrolysis resistance, comprising polycarbodiimides.

DE 198 09 634 A1 describes methods for producing carbodiimides and mixtures comprising carbodiimides and polyesters or polyurethanes.

WO 2005/111048 A1 describes carbodiimides comprising silane groups bonded by way of urea groups, and also mixtures of these with polymers.

EP 0 507 407 A1 describes polyfunctional water-dispersible crosslinking agents based on oligomeric substances, comprising carbodiimide and other reactive functional groups, for example heterocycles. Aqueous dispersions, emulsions, or solutions of these crosslinking agents are moreover described, as also are methods for producing the crosslinking agents.

Our unpublished patent application EP 11158914.9 describes the use of oligomeric carbodiimides, comprising at least one heterocyclic terminal group, as stabilizers for polymers.

U.S. Pat. No. 4,385,144 describes epoxyalkanes having from 10 to 50 carbon atoms in PET to improve the processing properties of the polymer.

U.S. Pat. No. 4,393,156 and U.S. Pat. No. 4,393,158 describe the use of epoxysilanes and epoxysiloxanes for stabilizing polyester carbonates or aromatic polycarbonates with respect to hydrolysis.

Alkylketene dimers are often used to hydrophobize paper or fibers, for example as described in U.S. Pat. No. 5,028,236 or WO 92/15746 A1.

JP 2007023100 A2 describes the use of alkylketene dimers in the stabilization of aliphatic polyesters.

U.S. Pat. No. 3,770,693 and U.S. Pat. No. 4,123,419 describe the use of oxazolidines as stabilizers for ester (co)polymers, in particular polyester urethanes.

Polymers, for example polycondensation polymers, e.g. polyesters, are often subject to degradation via hydrolysis at elevated temperatures. Conditions of this type arise by way of example on processing of the polymers with heating and with simultaneous presence of moisture. Hydrolysis of the polymers leads to a reduction of molecular weight and to a decrease in melt viscosity with simultaneous impairment of the mechanical properties of the polymers. Said effects severely restrict the usefulness of these hydrolyzable polymers and moreover incur high drying cost prior to processing of the polymers.

It was therefore an object of the present invention to provide stabilizers for polymers which reduce degradation and mitigate hydrolysis. A particular object of the invention was to suppress any decrease in the melt viscosity of polymers during processing.

Said objects were achieved via mixtures (M) comprising
a. at least one polyfunctional chain extender (K) having at least three reactive groups, and
b. at least one mono- or difunctional hydrolysis stabilizer (H),
   where, the chain extenders (K) and the hydrolysis stabilizers (H) react with the terminal groups of polymers (P) in the molten or solid state of the polymers (P) to form a chemical bond. It is preferable that the chain extenders (K) react with the terminal groups of polymers (P) in the molten state of the polymers (P) and that the hydrolysis stabilizers (H) react with the terminal groups of polymers (P) in the molten or solid state of the polymers (P).

For the purposes of this invention, expressions of the type Cₐ-C_{b} denote chemical compounds or substituents having a certain number of carbon atoms. The number of carbon atoms can be selected from the entire range from a to b, inclusive of a and b, and a is at least 1, and b is always greater than a. Further specification of the chemical compounds or of the substituents is achieved via expressions of the type Cₐ-C_{b}-V. V here represents a class of chemical compound or a class of substituent, for example alkyl compounds or alkyl substituents.

Halogen represents fluorine, chlorine, bromine, or iodine, preferably fluorine, chlorine, or bromine, particularly preferably fluorine or chlorine.

The individual meaning of the generic expressions used for the various substituents is as follows:

C₁-C₂₀-alkyl: straight-chain or branched hydrocarbon moieties having up to 20 carbon atoms, for example C₁-C₁₀-alkyl or C₁₁-C₂₀-alkyl, preferably C₁-C₁₀-alkyl for example C₁-C₃-alkyl, such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethyl-propyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-tri-methylpropyl, 1-ethyl-1-methylpropyl, 1-ethyl-2-methylpropyl, or C₇-C₁₀-alkyl, such as heptyl, octyl, 2-ethylhexyl, 2,4,4-trimethylpentyl, 1,1,3,3-tetramethylbutyl, nonyl, or decyl, and also isomers of these.

C₂-C₂₀-alkenyl: unsaturated, straight-chain, or branched hydrocarbon moieties having from 2 to 20 carbon atoms and having a double bond in any desired position, for example C₂-C₁₀-alkenyl or C₁₁-C₂₀-alkenyl, preferably C₂-C₁₀-alkenyl, such as C₂-C₄-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, or C₅-C₆-alkenyl, such as 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, or 1-ethyl-2-methyl-2-propenyl, and also C₇-C₁₀-alkenyl, such as the isomers of heptenyl, octenyl, nonenyl or decenyl.

C₂-C₂₀-alkynyl: straight-chain or branched hydrocarbon groups having from 2 to 20 carbon atoms and having a triple bond in any desired position, for example C₂-C₁₀-alkynyl, or C₁₁-C₂₀-alkynyl, preferably C₂-C₁₀-alkynyl, such as C₂-C₄-alkynyl, such as ethynyl, 1-propynyl, 2-propynyl, 1-butynyl, 2-butynyl, 3-butynyl, 1-methyl-2-propynyl, or C₅-C₇-alkinyl, such as 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, or 1-ethyl-1-methyl-2-propynyl, and also C₇-C₁₀-alkynyl, such as the isomers of heptynyl, octynyl, nonynyl, decynyl.

C₃-C₁₅-cycloalkyl: monocyclic, saturated hydrocarbon groups having from 3 to 15 ring-member carbon atoms, preferably C₃-C₈-cycloalkyl, such as cyclopropyl, cyclobutyl, cyclopentyl, cyclohexyl, cycloheptyl, or cyclooctyl, or else a saturated or unsaturated cyclic system, e.g. norbornyl or norbenyl.

Aryl: a mono- to trinuclear aromatic ring system comprising from 6 to 14 carbon ring members, e.g. phenyl, naphthyl, or anthracenyl, preferably a mono- to binuclear, particularly preferably a mononuclear, aromatic ring system.

C₁-C₂₀-Alkoxy means a straight-chain or branched alkyl group having from 1 to 20 carbon atoms (as mentioned above) linked by way of an oxygen atom (—O—), for example C₁-C₁₀-alkoxy or C₁-C₂₀-alkoxy, preferably C₁-C₁₀-alkyloxy, particularly preferably C₁₋C₃-alkoxy, for example methoxy, ethoxy, propoxy.

Heteroatoms are phosphorus, oxygen, nitrogen, or sulfur, preferably oxygen, nitrogen, of sulfur, where the free valencies of these have optionally been satisfied by H atoms.

In one particular embodiment of the invention, the chain extenders (K) are selected from the group of the homo- and copolymers comprising at least three epoxy groups, at least three aziridine groups, or at least three anhydride groups.

Homo- or copolymers comprising at least three epoxy groups are particularly preferred here as chain extenders (K). These chain extenders (K) very particularly preferably involve copolymers comprising at least three epoxy groups, in particular epoxy-functionalized copolymers comprising styrene and (meth)acrylic ester monomer in polymerized form.

Examples of these very preferred chain extenders (K) and production of these are described in U.S. Pat. No. 6,984,694 B2.

Preferred chain extenders (K) are copolymerization products of at least one monomer having at least one epoxy group and of at least one styrene and/or (meth)acrylic ester monomer. By way of example, these involve epoxy-functionalized (meth)acrylic ester monomers in combination with non-epoxy-functionalized styrene monomers and/or with (meth)acrylic ester monomers. For the purposes of the present application, the expression (meth)acrylic ester monomers covers not only acrylic ester monomers (acrylate monomers) but also methacrylic ester monomers (methacrylate monomers).

Examples of the epoxy-functionalized (meth)acrylic ester monomers comprise those comprising 1,2-epoxy groups, e.g. glycidyl acrylate and glycidyl methacrylate. Other epoxy-functionalized monomers comprise allyl glycidyl ether, glycidyl ethacrylate, and glycidyl itaconate.

Acrylate and methacrylate monomers which can be used for the purposes of the invention comprise, ignoring epoxy-functionalization, methyl acrylate, ethyl acrylate, n-propyl acrylate, n-hexyl acrylate, n-octyl acrylate, methyl methacrylate, ethyl methacrylate, n-propyl methacrylate, methylcyclohexyl methacrylate, isobornyl methacrylate, butyl acrylate, butyl methacrylate, isobutyl methacrylate, cyclohexyl acrylate, cyclohexyl methacrylate, isobornyl acrylate, isobornyl methacrylate, and mixtures of these.

Preferred non-functionalized acrylates and methacrylates comprise butyl acrylate, butyl methacrylate, methyl methacrylate, isobutyl methacrylate, cyclohexyl acrylate, cyclohexyl methacrylate, isobornyl acrylate, isobornyl methacrylate, and mixtures of these.

Styrene monomers which can be used for the purposes of the present invention comprise styrene, alpha-methylstyrene, vinyltoluene, p-methylstyrene, tent-butyl-styrene, o-chlorostyrene, vinylpyridines, and mixtures of these. In specific embodiments the monomers have been selected from styrene and alpha-methyl-styrene.

Particularly preferred copolymerization products comprise at least one monomer selected from glycidyl acrylate and glycidyl methacrylate, and comprise at least one monomer selected from styrene, methyl methacrylate, methyl acrylate, butyl acrylate, and ethylhexyl acrylate.

It is preferable that the copolymerization products of at least one monomer having at least one epoxy group and of at least one styrene and/or (meth)acrylic ester monomer have an epoxy equivalent weight (EEW) of from 180 to 2800 g/mol, preferably from 190 to 1400 g/mol, and particularly preferably from 200 to 700 g/mol. It is preferable that the Efn value (Efn=Mn/EEW) of said copolymerization products is less than 30, preferably from 2 to 20, and particularly preferably from 3 to 10. It is moreover preferable that the Efw value (Efw=Mw/EEW) of said copolymerization products is less than 140, preferably from 3 to 65, and particularly preferably from 6 to 45. Efn is the number-average epoxy functionality, and Efw is the weight-average epoxy functionality.

It is preferable that the number-average molar mass (Mn) of the copolymerization products of at least one monomer having at least one epoxy group and of at least one styrene and/or (meth)acrylic ester monomer is less than 6000 g/mol, preferably from 1000 to 5000 g/mol, and particularly preferably from 1500 to 4000 g/mol. It is moreover preferable that the weight-average molar mass (Mw) of these copolymerization products is less than 25 000 g/mol, preferably from 1500 to 18 000 g/mol, particularly preferably from 3000 to 13 000 g/mol, and in particular from 4000 to 8500 g/mol.

The EEW values correspond to the mass of the copolymerization product which has one equivalent of epoxy functionality, and they are determined in accordance with ASTM D1652-90 (Standard Test Method for Epoxy Content of Epoxy Resins (1990) Test Method B) or as by way of example in U.S. Pat. No. 6,552,144 B1 from the mass balance of the monomers used having epoxy groups.

The molecular weight distributions of the copolymerization products are determined with the aid of gel permeation chromatography (GPC) measurements. For this, the copolymerization products are first dissolved in tetrahydrofuran (THF) and then are injected into the GPC apparatus. An example of a GPC apparatus that can be used is a Waters 2695 apparatus with a Waters 2410 refractive index (RI) detector. Columns that can be used are PLGEL MIXED B columns with a monitoring column, permitting determination of inter alfa the Mn and Mw values.

Copolymerization products of at least one monomer having at least one epoxy group and at least one styrene and/or (meth)acrylic ester monomer are available commercially, for example as Joncryl® products from BASF SE.

In another preferred embodiment of the mixture of the invention, the hydrolysis stabilizers (H) are selected from the
a. oligomeric carbodiimides of the general formula (I)

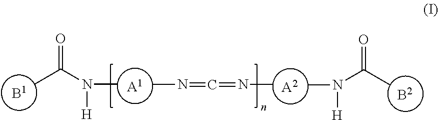

where A¹ and A² are mutually independently, being identical or different, hydrocarbon groups having from 3 to 20 carbon atoms, preferably comprising cyclic hydrocarbon moieties, in particular C₃-C₁₄ cycloalkylene, arylene,
B¹ and B² are mutually independently, being identical or different, heterocycles, C₁-C₃₀-alcohols, polyetherols, polyesterols, amines, polyetheramines, polyesteramines, thioalcohols, polyetherthiols, polyesterthiols,
n is an integer in the range from 2 to 100, preferably in the range from 2 to 50,
   particularly preferably in the range from 2 to 20,
   in particular in the range from 2 to 10,
and where A¹, A², B¹, and B² respectively can have substitution at any desired position by C₁-C₂₀-alkyl, C₂-C₂₀-alkenyl, C₂-C₂₀-alkynyl, C₁-C₂₀-alkoxy, carbonyl oxygen (═O) or halogen, preferably C₁-C₄-alkyl,
b. mono- or difunctional epoxy compounds of the general formula (IIa) or (IIb)

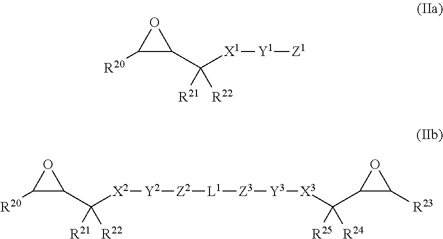

where
X¹, X², and X³ are mutually independently, being identical or different, CH₂, O, C(═O), OC(═O), C(═O)NH, preferably O or CH₂, particularly preferably O,
Y¹, Y², and Y³ are mutually independently, being identical or different, a single bond, C₁-C₂₀-alkylene, C₁-C₂₀-alkylenyl, arylene, preferably a single bond or C₁-C₂₀-alkylene, particularly preferably C₁-C₂₀-alkylene,
Z¹ is H, SiR¹R²R³, Si(OR¹)R²R³, Si(OR¹)(OR²)R³, Si(OR¹)(OR²)(OR³), preferably Si(OR¹)(OR²)(OR³),
Z² and Z³ are mutually independently, being identical or different, a single bond, SiR¹R², Si(OR¹)R², Si(OR¹)(OR²),
L¹ is a single bond, O, CH₂,
R¹, R², and R³ are mutually independently, being identical or different, C₁-C₂₀-alkyl, preferably C₁-C₁₀-alkyl, particularly preferably C₁₋C₄-alkyl, in particular C₁-C₂-alkyl,
R²⁰, R²¹, and R²² are mutually independently, being identical or different, H, C₁-C₂₀-alkyl, preferably H, or
   R²⁰ together with R²¹ or R²² is dimethylene, trimethylene, or tetramethylene, thus forming a five-, six-, or seven-membered ring system,
R²³, R²⁴, and R²⁵ are mutually independently, being identical or different, H, C¹-C²⁰-alkyl, preferably H, or
   R²³ together with R²⁴ or R²⁵ is dimethylene, trimethylene, or tetramethylene, thus forming a five-, six-, or seven-membered ring system,
c. alkylketene dimers of the general formula (III)

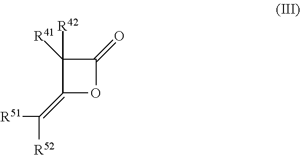

where
R⁴¹ and R⁴² are mutually independently, being identical or different, H or C₁-C₃₀-alkyl,
   preferably H or C₄-C₂₀-alkyl, particularly preferably H or C₆-C₁₈-alkyl,
R⁵¹ and R⁵² are mutually independently, being identical or different, H or C₁₋C₃₀-alkyl,
   preferably H or C₄-C₂₀-alkyl, particularly preferably H or C₆-C₁₈-alkyl,
d. heterocycles of the general formula (IV) or (V)

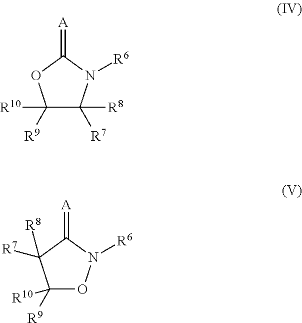

where
A is O or NR¹⁶,
R⁶ is H, C₁-C₂₀-alkyl, aryl, C₃-C₁₅-cycloalkyl, NR²⁶R²⁷,
   preferably H, C₁-C₁₀-alkyl, propionyl, acetyl, crotonyl,
   particularly preferably H, C₁-C₄-alkyl,
   in particular H, C₁-C₂-alkyl,
R¹⁶ is H, C₁-C₂₀-alkyl, aryl, C₃-C₁₅-cycloalkyl, halogen,
   preferably H, C₁-C₁₀-alkyl, aryl,
   particularly preferably H, C₁-C₄-alkyl, phenyl, tolyl,
R²⁶ and R²⁷ are mutually independently, being identical or different, H, C₁-C₂₀-alkyl, aryl, C₃-C₁₅-cycloalkyl,
   preferably H, C₁-C₁₀-alkyl, aryl,
   particularly preferably H, C₁-C₄-alkyl, phenyl, tolyl,
R⁷, R⁸, R⁹, and R¹⁰ are mutually independently, being identical or different, H, C₁-C₂₀-alkyl, aryl, C₃-C₁₅-cycloalkyl,
   preferably H, C₁-C₁₈-alkyl, aryl, C₅-C₈-cycloalkyl,
   particularly preferably H, C₁-C₄-alkyl,
   in particular H, C₁-C₂-alkyl,
where R⁶ and R¹⁶ respectively can have substitution at any desired position by C₁₋C₂₀-alkyl, C₂-C₂₀-alkenyl,
C₂-C₂₀-alkynyl, C₁-C₂₀-alkoxy, carbonyl oxygen (═O) or halogen,
preferably C₁-C₄-alkyl, C₂-C₁₀-alkenyl, carbonyl oxygen (═O).

Further advantages of these hydrolysis stabilizers (H) are that they have no adverse effect on melt viscosity, color, haze, or the odor of polymers.

It is preferable that the hydrolysis stabilizers (H) are selected in such a way that melt viscosity does not increase substantially during the extrusion process, preferably by less than 20%, particularly preferably by less than 10%, in such a way that the targeted viscosity is achieved in essence by way of the addition of the chain extender (K).

Oligomeric carbodiimides c. of the general formula (I) can, as described by way of example in EP 0 507 407 A1 or in our unpublished patent application EP 11158914, be produced by the process known to the person skilled in the art. A general production process for producing oligomeric carbodiimides comprising at least one heterocyclic terminal group comprises by way of example the reaction of a diisocyanate with a polyetherol and with a heterocycle.

In another preferred embodiment, the substituents Aland A² of the oligomeric carbodiimides of the general formula (I) comprise the following hydrocarbon groups:

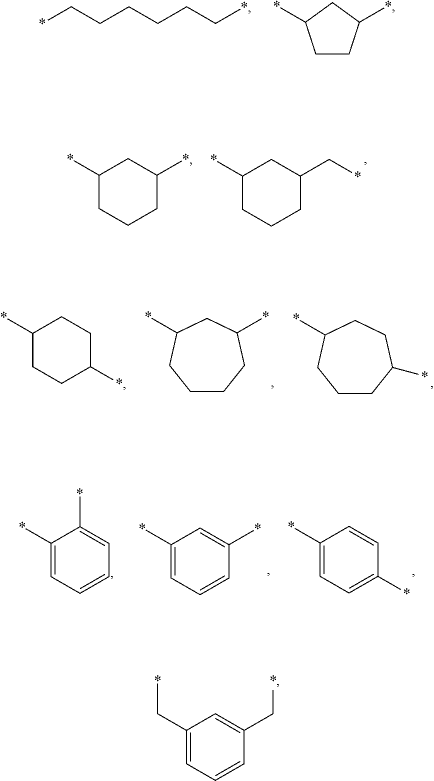

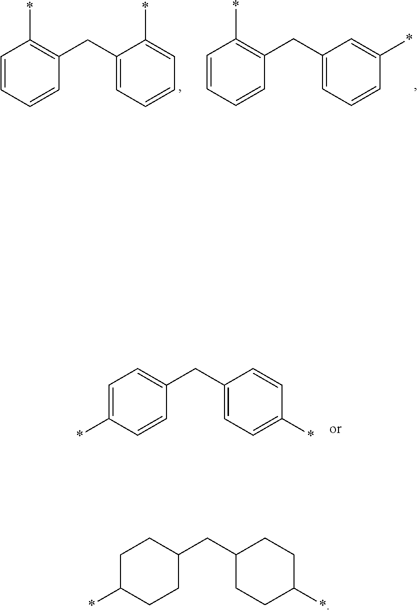

It is preferable that the substituents A¹ and A² of the oligomeric carbodiimides comprise the following hydrocarbon groups:

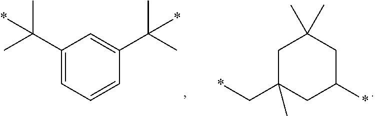 [SMILES: *C(C)(C)c1cccc(C(*)(C)C)c1 ; *CC1(C)CC(*)CC(C)(C)C1]

In one preferred embodiment of the mixture of the invention, the substituents B¹ and B² of the carbodiimides are selected from the group of the three- to twelve-membered, preferably three- to nine-membered, particularly preferably five- to seven-membered ring systems having oxygen atoms, nitrogen atoms, and/or sulfur atoms, and having one or more rings (heterocycles, heterocyclic terminal groups), e.g. aziridine, epoxide, thiirane, azirine, oxirene, thiirene, azetidine, oxetane, thietane, beta-lactam, beta-lactone, thiethanone, furan, pyrroline, dihydrofuran, dihydrothiophene, pyrolidine, tetrahydrofuran, tetrahydrothiophene, oxazolidine, dioxolane, oxathiolane, thiazolidine, imidazoline, dithiolane, pyrazolidine, pyrazoline, oxazoline, thiazoline, imidazoline, dioxole, oxazolone, pyrrolidone, butyrolactone, thiobutyrolactone, butyrothiolactone, thiobutyrothiolactone, oxazolidone, dioxolan-2-one, thiazolidinone, dihydropyridine, tetrahydropyridine, pyran, dihydropyran, tetrahydropyran, succinic anhydride, succinimide, thiopyran, dihydrothiopyran, tetrahydrothiopyran, dihydropyrimidine, tetrahydropyrimidine, hexahydropyrimidine, dioxane, morpholine, thiamorpholine, dithiane, triazine, where these have chemical linkage in any desired manner within the general formula (I), for example by way of a bond to a carbon atom of the heterocycle or by way of a bond to one of the heteroatoms.

Particular preference is given to five-, six-, or seven-membered saturated nitrogen-containing ring systems which have linkage by way of a ring nitrogen atom or ring carbon atom and which can also comprise one or two further nitrogen atoms or oxygen atoms. These are very particularly preferably selected here from the group of the following:

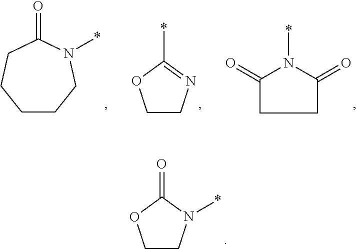

In one particularly preferred embodiment, the following applies to the substituents of the carbodiimides: A¹=A² and B¹=B².

Epoxy compounds b. of the general formulae (IIa) and (IIb) and production of these are within the general knowledge of the person skilled in the art, for example from U.S. Pat. No. 4,385,144, U.S. Pat. No. 4,393,156, or U.S. Pat. No. 4,393,158. Epoxy compounds of the general formulae (IIa) and (IIb) are available commercially.

Alkylketene dimers c. of the general formula (III) and production of these are within the general knowledge of the person skilled in the art, for example from U.S. Pat. No. 5,028,236 or WO 92/15746 A1. Alkylketene dimers of the general formula (III) are available commercially.

Heterocycles (oxazolidinones and derivatives or isomers) d. of the general formulae (IV) and (IV) and production of these are within the general knowledge of the person skilled in the art, for example from U.S. Pat. No. 3,770,693 or U.S. Pat. No. 4,123,419. Heterocycles of the general formulae (IV) and (V) are available commercially.

The quantitative ratio between the at least one polyfunctional chain extender (K) and the at least one mono- or difunctional hydrolysis stabilizer (H) in the mixture (M) can vary widely as a function of application. By way of example, larger amounts of chain extenders (K) are used in applications which require higher initial viscosity, e.g. PET recycling. In applications where the polymers have exposure to relatively high temperatures and relatively high humidity, the proportion of the hydrolysis stabilizers increases correspondingly. The person skilled in the art can use appropriate experimentation to set a suitable ratio. The quantitative ratio (weight) of K to H is generally in the range from 1:100 to 100:1, preferably from 1:50 to 50:1, very preferably from 1:20 to 20:1, and in particular from 1:10 to 10:1.

In another embodiment of the mixture of the invention, the polymers (P) are polycondensates or polyadducts. It is preferable that the polymers are selected from the group of the polyesters, polyamides, polyurethanes, polycarbonates, and their copolymers and/or mixtures. In particular, the polymers to be stabilized are those selected from PET (polyethylene terephthalate), PBT (polybutylene terephthalate), PEN (polyethylene naphthalate), PC (polycarbonate), biodegradable aliphatic-aromatic copolyesters, biopolymers, and PA6 (nylon-6). Particularly suitable biodegradable aliphatic-aromatic copolyesters are poly(butylene adipates-co-terephthalates), and biopolymers that can in particular be used are PLA (polylactic acid) and PHA (polyhydroxyalkanoates). Particularly suitable mixtures are PC/ABS (acrylonitrile-butadiene-styrene copolymer) mixtures. The stabilized polymers also, of course, comprise recycled or regenerated polymers. In one preferred embodiment of the mixture of the invention, the polymers (P) moreover comprise terminal hydroxy groups, terminal amine groups, terminal carboxy groups, or terminal carboxylic acid groups, in particular terminal carboxylic acid groups.

The present invention further provides mixtures (MP) comprising
a. at least one mixture (M) described above and
b. in addition, at least one polymer (P) described above.

In one preferred embodiment of the mixture (MP) of the invention, at least one mixture (M) is added to the at least one polymer (P) in an amount of from 0.01 to 10% by weight, preferably from 0.1 to 5% by weight, in particular from 0.1 to 2% by weight, based on the total amount of polymer (P) and mixture (M).

The incorporation of the mixtures (M) into the polymers (P) is generally achieved via mixing of the constituents. By way of example, the mixing is achieved via methods known to the person skilled in the art, these being those generally used in providing additives to polymers. The mixtures (M) in solid, liquid or dissolved form are preferably used to modify polyaddition polymers or polycondensation polymers. To this end, the mixtures (M) can take the form either of solid or of liquid formulation, or else of powder, when they are incorporated into the polymers by the usual methods. By way of example, mention may be made here of the mixing of the mixtures (M) with the polymers (P) prior to or during an extrusion step, kneading, calendering, film extrusion, fiber extrusion, or blow molding. The constituents can be mixed prior to the incorporation process, with or without the help of a solvent. The solvent can optionally be removed prior to the incorporation process. Further examples for the modification or stabilization of polymers with additives can be found in Plastics Additives Handbook, 5th edition, Hanser Verlag, ISBN 1-56990-295-X. The polymers with additives can by way of example take the form of granulated materials, pellets, powders, films, or fibers.

Polymer moldings which comprise the mixture (M) are produced by methods known to the person skilled in the art. In particular, the polymer moldings can be produced via extrusion or coextrusion, compounding, processing of granulated materials or pellets, injection molding, blow molding, or kneading. Preference is given to processing via extrusion or coextrusion to give films (cf. Saechtling Kunststoff Taschenbuch [Plastics Handbook], 28th edition, Karl Oberbach, 2001).

The polymers or polymer moldings can comprise, in addition, at least one further, often commercially obtainable, additive preferably selected from colorants, antioxidants, other stabilizers, e.g. hindered amine light stabilizers (HALS), UV absorbers, nickel quenchers, metal deactivators, reinforcing materials and fillers, antifogging agents, biocides, acid scavengers, antistatic agents, IR absorbers for long-wave IR radiation, antiblocking agents, such as SiO₂, light-scattering agents, such as MgO or TiO₂, and inorganic or organic reflectors (for example aluminum flakes). It is equally possible to use other chain extenders or hydrolysis stabilizers not comprised within the mixtures (M).

The invention further provides the use of mixtures (M) described above where these are stabilizers for polymers (P) described above, and in particular provides the use for stabilization with respect to molecular weight loss and/or hydrolysis.

The invention further provides a method for stabilizing polymers (P), in particular with respect to molecular weight loss and/or hydrolysis, where an effective amount of mixture (M) is added to the polymer (P). It is preferable that an amount (M) of from 0.01 to 10% by weight, based on the total amount of polymer (P) and mixture (M) is added to the polymer (P). For the purposes of the stabilization method of the invention, the additives described above are moreover added to the polymer (P).

The present invention provides mixtures (M) which have a stabilizing effect for polymers, where these reduce degradation and mitigate the hydrolysis of the polymers, in particular during processing of these.

The examples provide further explanation of the invention, but do not restrict the subject matter of the invention.

### EXAMPLES

Polyethylene terephthalate (PET) with intrinsic viscosity 69 ml/g for producing biaxially oriented films was purchased from Mitsubishi Polyester Film GmbH, Wiesbaden. The PET had a low concentration of terminal carboxylic groups (about 21 mmol/kg). The acid numbers are obtained by titrating the respective PET solution in a solvent mixture made of chloroform/cresol.

The additives were extruded in various concentrations at a temperature of 260° C. together with the PET. The resultant films were then exposed to elevated temperatures (110° C.) and high humidity (100%) and stored for a period of two or five days. The degradation of the polymer was determined by measuring intrinsic viscosity (IV) and/or concentration of terminal acid groups in the PET prior to and after storage. The IV measurements (units mg/l) were made by using a micro-Ubbelohde capillary viscometer, and using a 1:1 mixture of phenol and o-dichlorobenzene as solvent.

The PBT matrix used comprised Ultradur® B4520 (BASF SE) with intrinsic viscosity 118 ml/g and acid number about 25 mmol/kg. Coextrusion was used to add additives to the PBT, and moldings were produced for tensile tests. Intrinsic viscosities and terminal acid groups were determined on portions of the test specimens prior to and after storage at 110° C. and 100% humidity.

Unless otherwise stated, the reference (Ref.) used comprises the respective polymers, such as PET or PBT, extruded without hydrolysis stabilizer or chain extender.

### Comparative Example 1

### Joncryl Products

This example used two types of Joncryl:

Joncryl® ADR 4368 (styrene/acrylate copolymer, Mw=6.800 g/mol, EEW=285 g/mol)

Joncryl® ADR 4300 (styrene/acrylates copolymer, Mw=5.500 g/mol, EEW=445 g/mol)

Table 1.1 compares the intrinsic viscosities and terminal acid group concentrations with the reference (Ref.).

TABLE 1.1

| Polymer | Joncryl | IV [ml/g] | | COOH [mmol/kg] | | |
|---|---|---|---|---|---|---|
| matrix | [% by wt.] | 0 | 2 days | 0 | 2 days | 5 days |
| PET | Ref. | 69 | 53 | 25 | 43 | 92 |
| PET | 0.2% | 71 | 60 | 24 | 42 | 90 |
| | ADR4300 | | | | | |
| PET | 0.4% | 78 | 62 | 21 | 38 | 82 |
| | ADR4300 | | | | | |
| PET | 0.2% | 78 | 58 | 23 | 39 | 88 |
| | ADR4368 | | | | | |
| PBT | Ref. | 118 | 92 | 29 | 47 | 110 |
| PBT | 0.2% | 120 | 93 | 25 | 38 | 72 |
| | ADR4300 | | | | | |
| PBT | 0.4% | 130 | 104 | 23 | 35 | 68 |
| | ADR4300 | | | | | |

The stated amount of Joncryl® is based on the total amount of Joncryl® and polymer. The concentration of terminal acid groups is based on the total amount of Joncryl® and polymer.

The Joncryl® products markedly increase melt viscosity after extrusion of the films. However, only small concentrations of Joncryl® can be used if an undesired rise in viscosity during processing is to be avoided (for example 0.2% by weight of Joncryl® 4300), and these concentrations do not prevent the increase in terminal acid groups during storage.

Table 1.2 collates the variation of intrinsic viscosity during storage of the films. The data are the same as in table 1.1. However, the reference (reference quantity) selected is now the intrinsic viscosity of the respective specimen prior to storage.

TABLE 1.2

| | PET | ADR 4300 | ADR 4368 |
|---|---|---|---|
| IV of extruded PET film [mL/g] | 69 | 78 | 78 |
| Delta IV after 2 days of storage | −23 | −21 | −26 |
| at 110° C./100% humidity [%] | | | |
| IV of PBT test specimen [mL/g] | 118 | 130 | — |
| Delta IV after 2 days of storage | −22 | −20 | — |
| at 110° C./100% humidity [%] | | | |

It is clear that the Joncryl® alone was not capable of effectively suppressing degradation of the polymer during storage. In all cases, intrinsic viscosity had already fallen by from 20 to 25% after two days of storage, with no difference from the polymer without Joncryl® addition.

### Inventive example 2

### Alkylketene Dimer (AKD) Compounds

Tables 2.1 and 2.2 show the stabilization of polymers such as PET and PBT with respect to hydrolysis by the AKD with the formula (III′):

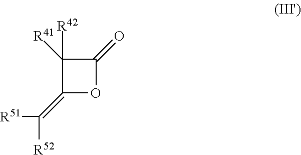

where

R⁴¹, R⁴² are H, (CH₂)₁₅—CH₃

R⁵¹, R⁵² are H, (CH₂)₁₅—CH₃,

where the formula (III′) represents a mixture of the isomers in which R⁴¹ and R⁴² and, respectively, R⁵¹ and R⁵² are not simultaneously H or (CH₂)₁₅—CH₃.

Table 2.1 compares the effect of the AKD alone.

TABLE 2.1

| | AKD | COOH [mmol/kg] | | |
|---|---|---|---|---|
| Polymer | [% by wt.] | Prior to storage | After two days | After five days |
| PET | Ref. | 24 | 54 | 150 |
| PET | 0.4 | 21 | 43 | 95 |
| PET | 0.8 | 19 | 45 | 100 |
| PBT | Ref. | 29 | 47 | 110 |
| PBT | 0.4 | 26 | 43 | 88 |
| PBT | 0.8 | 25 | 41 | 79 |

The stated amount of AKD is based on the total amount of AKD and polymer. The concentration of terminal acid groups is based on the total amount of AKD and polymer.

The AKD inhibits the increase in terminal acid groups during storage. However, intrinsic viscosity does not rise significantly during the extrusion process.

Table 2.2 compares the efficiency of use of AKD alone and in conjunction with the chain extender Joncryl® ADR 4300. It can clearly be seen that a combination of hydrolysis stabilizer (H) and chain extender (H) has a synergistic effect.

TABLE 2.2

| | | IV [mL/g] | | COOH [mmol/kg] | | |
|---|---|---|---|---|---|---|
| | Joncryl ADR | | After | | After | After |
| AKD | 4300 | | two | | two | five |
| [% by wt.] | [% by wt.] | 0 | days | 0 | days | days |
| Ref. | Ref. | 118 | 92 | 29 | 47 | 110 |
| 0.4 | — | 119 | 99 | 26 | 43 | 88 |
| 0.4 | 0.2 | 125 | 104 | 20 | 34 | 65 |

The stated amount of AKD and Joncryl® ADR 4300 is based in each case on the total amount of AKD and/or Joncryl® ADR 4300 and polymer.

The concentration of terminal acid groups is based on the total amount of AKD and/or Joncryl® ADR 4300 and polymer.

### Inventive Example 3

### Oxazolidinones

Table 3.1 shows results achieved with the oxazolidinone of the formula (IV′) in PBT:

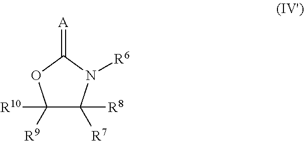

where A=O, R⁶═R⁷═R⁸═R⁹═R¹⁰═H.

TABLE 3.1

| | IV [mL/g] | | | COOH [mmol/kg] | | |
|---|---|---|---|---|---|---|
| 2-Oxazolidinone | | After | After | | After | After |
| (IV′) | | two | five | | two | five |
| [% by wt.] | 0 | days | days | 0 | days | days |
| Ref. | 118 | 92 | 57 | 29 | 47 | 110 |
| 0.4 | 117 | 98 | 64 | 27 | 45 | 89 |
| 1.0 | — | — | — | 29 | 42 | 80 |

The stated amount of oxazolidinone is based on the total amount of oxazolidinone and polymer.

The concentration of terminal acid groups is based on the total amount of oxazolidinone and polymer.

The effect shown in table 3.1 for the oxazolidionone in PBT, namely its small effect on initial viscosity and the reduction of terminal acid group concentration during storage, can be combined synergistically with the effect of a chain extender (Joncryl® ADR 4300), just as in the case of the AKD in inventive example 2.

### Inventive Example 4

### Monoepoxy and Monoepoxysilane Compounds

Tables 4.1 and 4.2 show the results of extrusion of PET or PBT in the presence of an epoxysilane: 3-glycidoxypropyltriethoxysilane, which is obtainable as Geniosil® GF 82 (Wacker Chemie AG). The tables also comprise results for the use of 1,2-epoxydecane as hydrolysis stabilizer.

Both additives (hydrolysis stabilizers) significantly mitigate the degradation of the polyester during storage, without increasing initial intrinsic viscosity.

TABLE 4.1
(PET)

| | | COOH [mmol/kg] | | |
|---|---|---|---|---|
| | Concentration | Prior to | After | After |
| Additive | [% by wt.] | storage | two days | five days |
| Ref. | — | 24 | 45 | 107 |
| 3-Glycidoxy- | 0.2 | 23 | 36 | 74 |
| propyltriethoxy- | 1.0 | 14 | 22 | 46 |
| silane | 2.0 | 12 | 10 | 40 |
| Ref. | — | 26 | 46 | 114 |
| 3-Glycidoxy- | 1.0 | 13 | 23 | 59 |
| propyltriethoxy- | | | | |
| silane (repetition | | | | |
| to check | | | | |
| reproducibility) | | | | |
| Ref. | — | 24 | 54 | 147 |
| 1,2-epoxydecane | 0.8 | 22 | 39 | 98 |
| Ref. | — | 24 | 43 | 95 |
| 1,2-epoxydecane | 0.2 | 25 | 41 | 91 |
| | 1.0 | 22 | 37 | 82 |
| | 2.0 | 20 | 34 | 75 |

The stated concentration of additive is based on the total amount of additive and polymer.

The concentration of terminal acid groups is based on the total amount of additive and polymer.

TABLE 4.2
(PBT)

| | | COOH [mmol/kg] | | |
|---|---|---|---|---|
| | Concentration | Prior to | After | After |
| Additive | [% by wt.] | storage | two days | five days |
| Ref. | — | 29 | 47 | 110 |
| 3-Glycidoxy- | 0.4 | 17 | 27 | 52 |
| propyltriethoxy- | 2.0 | 18 | 22 | 40 |
| silane | | | | |
| | | IV [mL/g] | | |
| Ref. | — | 118 | 92 | 57 |
| 3-Glycidoxy- | 0.4 | 118 | 102 | 73 |
| propyltriethoxy- | | | | |
| silane | | | | |

The stated concentration of additive is based on the total amount of additive and polymer.

The concentration of terminal acid groups is based on the total amount of additive and polymer.

It was also possible to add the additives in the form of a masterbatch and thus obtain the advantageous effect as hydrolysis stabilizer in the final product. To this end, a first step produced the masterbatch by extruding, in about 800 g of PBT, the amount of hydrolysis stabilizer necessary to provide full stabilization of 5 kg of extruded PBT via reaction with the terminal acid groups (about 30 mmol/kg).

The concentration of terminal acid groups in the masterbatch was determined prior to storage and after two days of storage at 110° C. and 100% humidity.

The masterbatch was then re-extruded in a second step in PBT (total amount of starting materials being 5 kg). The concentration of terminal acid groups in the final product was likewise determined prior to storage and after two days of storage at 110° C. and 100% humidity. Table 4.3 collates the results:

TABLE 4.3
(PBT masterbatch and final product)

| | Masterbatch COOH | | Final product COOH | |
|---|---|---|---|---|
| | [mg/kg] | | [mmol/kg] | |
| | Prior to | After | Prior to | After |
| Additive | storage | two days | storage | two days |
| Ref. | — | — | 27 | 42 |
| 3-Glycidoxypropyl- | 15 | 12 | 21 | 30 |
| triethoxysilane | | | | |
| 1,2-epoxydecane | 14 | 10 | 22 | 31 |
| Bisphenol A diglycidyl | 17 | 18 | 22 | 33 |
| ether | | | | |

The stated concentration of additive is based on the total amount of additive and polymer.

The concentration of terminal acid groups is based on the total amount of additive and polymer.

The monoepoxy compounds in particular cause very little increase of initial viscosity during extrusion and therefore can advantageously be combined synergistically with chain extenders as described above in inventive examples 2 and 3.

Table 4.4 compares the effect of 1,2-epoxydecane alone and in combination with Joncryl® ADR 4300.

TABLE 4.4

| | | COOH [mmol/kg] | | |
|---|---|---|---|---|
| | Concentration | Prior to | After | After |
| Additive | [% by wt.] | storage | two days | five days |
| Ref. | — | 24 | 43 | 95 |
| 1,2-epoxydecane | 0.2 | 25 | 41 | 91 |
| 1,2-epoxydecane | 0.8 | 22 | 37 | 82 |
| 1,2-epoxydecane/ | 0.2/0.2 | 23 | 38 | 86 |
| Joncryl ® ADR | | | | |
| 4300 | | | | |

The stated concentration of additive is based on the total amount of additive and polymer.

The concentration of terminal acid groups is based on the total amount of additive and polymer.

1. A mixture (M) comprising
a. at least one polyfunctional chain extender (K) having at least three reactive groups, and
b. at least one mono- or difunctional hydrolysis stabilizer (H),
where,
the chain extenders (K) and the hydrolysis stabilizers (H) react with the terminal groups of polymers (P) in the molten or solid state of the polymers (P) to form a chemical bond.

2. The mixture according to claim 1, where the chain extenders (K) are selected from the group of the homo- and copolymers comprising at least three epoxy groups, at least three aziridine groups, or at least three anhydride groups.

3. The mixture according to claim 2, where the copolymers comprising at least three epoxy groups involve epoxy-functionalized copolymers comprising styrene and (meth)acrylic acid monomer in polymerized form.

4. The mixture according to claims 1 to 3, where the hydrolysis stabilizers (H) are selected from the
a. oligomeric carbodiimides of the general formula (I) 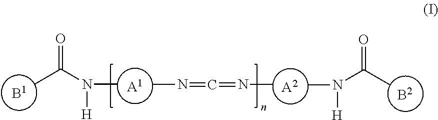
where A¹ and A² are mutually independently, being identical or different, hydrocarbon groups having from 3 to 20 carbon atoms,
B¹ and B² are mutually independently, being identical or different, heterocycles, C₁-C₃₀ alcohols, polyetherols, polyesterols, amines, polyetheramines, polyesteramines, thioalcohols, polyetherthiols, polyesterthiols,
n is an integer in the range from 2 to 100,
and where A¹, A², B¹, and B² respectively can have substitution at any desired position by C₁-C₂₀-alkyl, C₂-C₂₀-alkenyl, C₂-C₂₀-alkynyl, C₁-C₂₀-alkoxy, carbonyl oxygen (═O) or halogen,
b. mono- or difunctional epoxy compounds of the general formula (IIa) or (IIb) 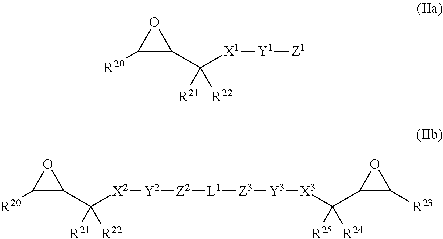
where
X¹, X², and X³ are mutually independently, being identical or different, CH₂, O, C(═O), OC(═O), C(═O)NH,
Y¹, Y², and Y³ are mutually independently, being identical or different, a single bond, C₁-C₂₀-alkylene, C₁-C₂₀-alkylenyl, arylene,
Z¹ is H, SiR¹R²R³, Si(OR¹)R²R³, Si(OR¹)(OR²)R³, Si(OR¹)(OR²)(OR³),
Z² and Z³ are mutually independently, being identical or different, a single bond, SiR¹R², Si(OR¹)R², Si(OR¹)(OR²),
L¹ is a single bond, O, CH₂,
R¹, R², and R³ are mutually independently, being identical or different, C₁-C₂₀-alkyl,
R²⁰, R²¹, and R²² are mutually independently, being identical or different, H, C₁-C₂₀-alkyl, or
R²⁰ together with R²¹ or R²² is dimethylene, trimethylene, or tetramethylene, thus forming a five-, six-, or seven-membered ring system,
R²³, R²⁴, and R²⁵ are mutually independently, being identical or different, H, C₁-C₂₀-alkyl, or
R²³ together with R²⁴ or R²⁵ is dimethylene, trimethylene, or tetramethylene, thus forming a five-, six-, or seven-membered ring system,
c. alkylketene dimers of the general formula (III) 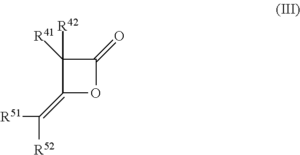
where
R⁴¹ and R⁴² are mutually independently, being identical or different, H or C₁-C₃₀-alkyl,
R⁵¹ and R⁵² are mutually independently, being identical or different, H or C₁-C₃₀-alkyl,
d. heterocycles of the general formula (IV) or (V) 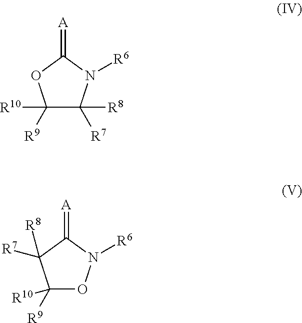
where
A is O or NR¹⁶,
R⁶ is H, C₁-C₂₀-alkyl, aryl, C₃-C₁₅-cycloalkyl, NR²⁶R²⁷,
R¹⁶ is H, C₁-C₂₀-alkyl, aryl, C₃-C₁₅-cycloalkyl, halogen,
R²⁶ and R²⁷ are mutually independently, being identical or different, H, C₁-C₂₀-alkyl, aryl, C₃-C₁₅-cycloalkyl,
preferably H, C₁-C₁₀-alkyl, aryl,
particularly preferably H, C1-C4-alkyl, phenyl, tolyl,
R⁷, R⁸, R⁹, and R¹⁰ are mutually independently, being identical or different, H, C₁-C₂₀-alkyl, aryl, C₃-C15-cycloalkyl,
where R⁶ and R¹⁶ respectively can have substitution at any desired position by C₁₋C₂₀-alkyl, C₂-C₂₀-alkenyl, C₂-C₂₀-alkynyl, C₁-C₂₀-alkoxy, carbonyl oxygen (═O) or halogen.

5. The mixture according to claims 1 to 4, where the polymers (P) are polycondensates or polyadducts.

6. The mixture according to claim 5, where the polymers (P) are selected from the group of the polyesters, polyamides, polyurethanes, polycarbonates, and copolymers of these, and also mixtures of said polymers.

7. The mixture according to claim 5, where the polymers (P) are PET, PBT, PEN, PC, biodegradable aliphatic-aromatic copolyesters, biopolymers, or PA6.

8. The mixture according to claims 1 to 7, where the polymers (P) comprise terminal hydroxy groups, terminal amine groups, terminal carboxy groups, or terminal carboxylic acid groups.

9. A mixture (MP) comprising
a. at least one mixture (M) according to claims 1 to 8 and
b. in addition, polymers (P) according to claims 1 to 8.

10. The use of mixtures (M) according to claims 1 to 8 as stabilizers for polymers (P).

11. The use according to claim 10 for stabilization with respect to molecular weight loss or to hydrolysis.

12. A method for stabilizing polymers (P) with respect to molecular weight loss, which comprises adding, to the polymer (P), an effective amount of mixture (M) according to claims 1 to 8.

13. The method according to claim 12, wherein polymers (P) in an amount of from 0.01 to 10% by weight, based on the total amount of polymers (P) and mixture (M), are added to the mixture (M).

14. The method according to claim 12 or 13, wherein, in addition, an effective amount of an additive selected from the group of the colorants, antioxidants, other stabilizers, UV absorbers, nickel quenchers, metal deactivators, reinforcing materials and fillers, antifogging agents, biocides, acid scavengers, antistatic agents, IR absorbers for long-wave IR radiation, antiblocking agents, light-scattering agents, and inorganic and organic reflectors is added to the polymer (P).
